(19) United States
(12) Patent Application Publication
(10) Pub. No.: US 2026/0102966 A1
(43) Pub. Date: Apr. 16, 2026

(54) METHOD OF STRUCTURAL REINFORCING 3D PRINTED CHANNEL LETTERS

(71) Applicants: Xiao Wei Jiang, Guangdong Province (CN); Wenxin Liu, Guangdong Province (CN)

(72) Inventors: Xiao Wei Jiang, Guangdong Province (CN); Wenxin Liu, Guangdong Province (CN)

(21) Appl. No.: 18/915,703

(22) Filed: Oct. 15, 2024

(51) Int. Cl. B29C 64/188; B33Y 10/00; B33Y 80/00

(52) U.S. Cl. CPC B29C 64/188; B33Y 10/00; B33Y 80/00

(57) ABSTRACT

A method of structurally reinforcing 3D printed channel letters is provided to enhance the strength of channel letters. A reinforcing fortifying layer is 3D printed in the space between the side walls of the channel letter and an additional outer layer is printed over the fortifying layer in order to encapsulate the fortifying layer.

### FIELD OF THE INVENTION

The present invention relates to 3D printing technology, specifically to the structural reinforcement of 3D printed channel letters to enhance their durability and strength.

### BACKGROUND OF THE INVENTION

3D printing technology is increasingly popular in various industries, including signage manufacturing. Channel letters, commonly used in signs, are typically printed in layers using filament-based 3D printing machines. However, the layered structure often lacks the necessary strength, especially at the edges (or turnarounds), where the letters are prone to breakage or deformation.

As seen in FIG. 1, the conventional approach to 3D printing channel letter 1 involves the building up of layers that form connected side walls 2 and 4. Unfortunately, this method results in a fragile structure, since the layered side walls do not provide sufficient internal reinforcement. This leads to weak spots that can easily break under pressure.

### SUMMARY OF THE INVENTION

It is thus the object of the present invention to overcome the disadvantages and limitations of prior 3D channel letter printing methods.

This and other objects are accomplished by the method of the present invention which enhances the strength of 3D printed channel letters by introducing a reinforcing fortifying layer having a structural pattern within the space between the side wall of the letters.

By this approach, the two outer sidewalls are printed first to form the basic shape of the channel letter. In the space between the side walls, an internal fortifying layer having a structural pattern is added. The patterns could take the form of an X-shaped or S-shaped design structure. These patterns create a stronger bond between the side walls, distributing stress more evenly and increasing the overall durability of the letter. Once the internal reinforcement is printed, an additional outer layer is added to encapsulate the fortifying layer and complete the channel letter.

The result of this method design ensures that the side walls are significantly more robust, minimizing the risk of breakage and improving the longevity of the printed channel letters.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an example of the prior art.

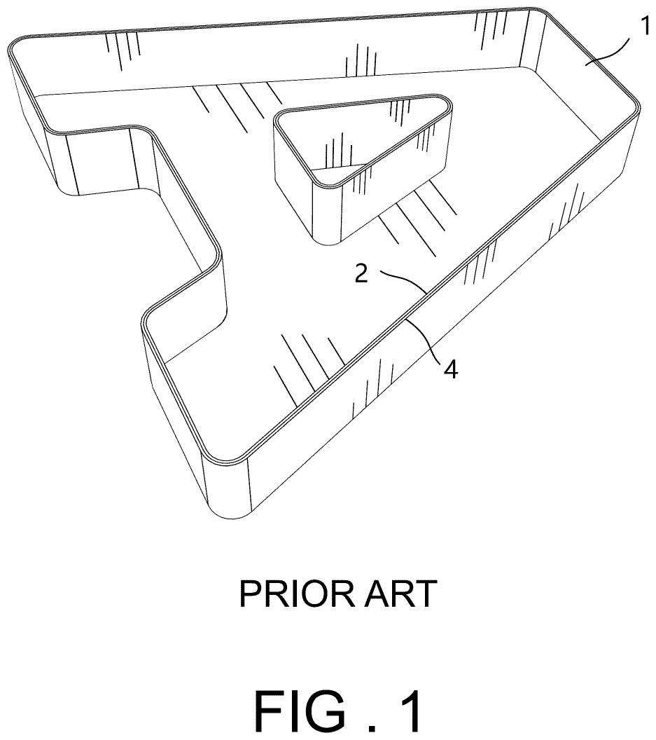

FIG. 2 illustrates the 3D printing of the outer and inner side walls of the channel letter.

FIG. 3 illustrates the 3D printing of the fortifying layer of the channel letter.

FIG. 4 illustrates the 3D printing of the outer layer.

FIG. 5 is a detailed view of the 3D printing of the outer layer as shown in FIG. 4.

FIG. 6 is a front view of the 3D printed outer layer.

FIG. 7 is a front view showing the relationship between the fortifying and the outer layers.

FIG. 8 is a perspective view of the fully fabricated channel letter.

### DETAILED DESCRIPTION OF THE INVENTION

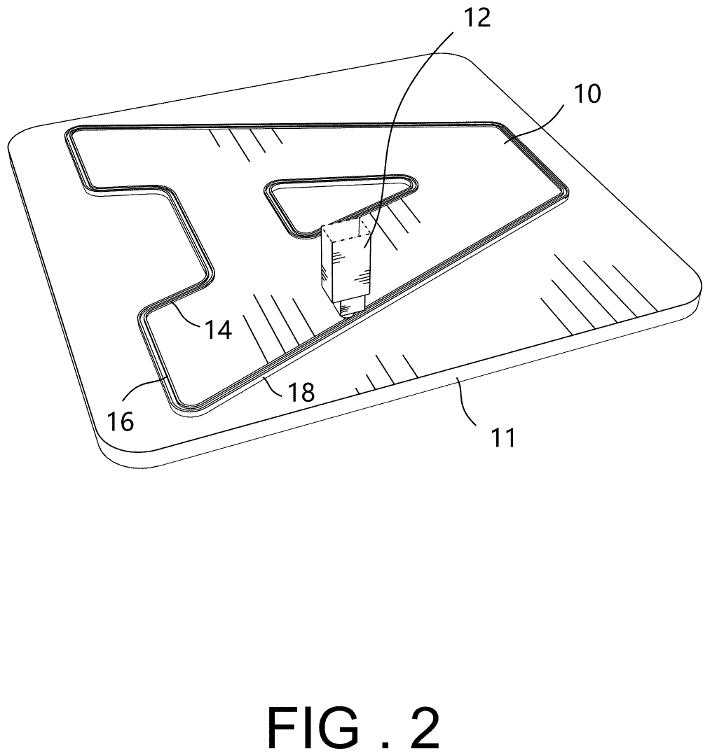

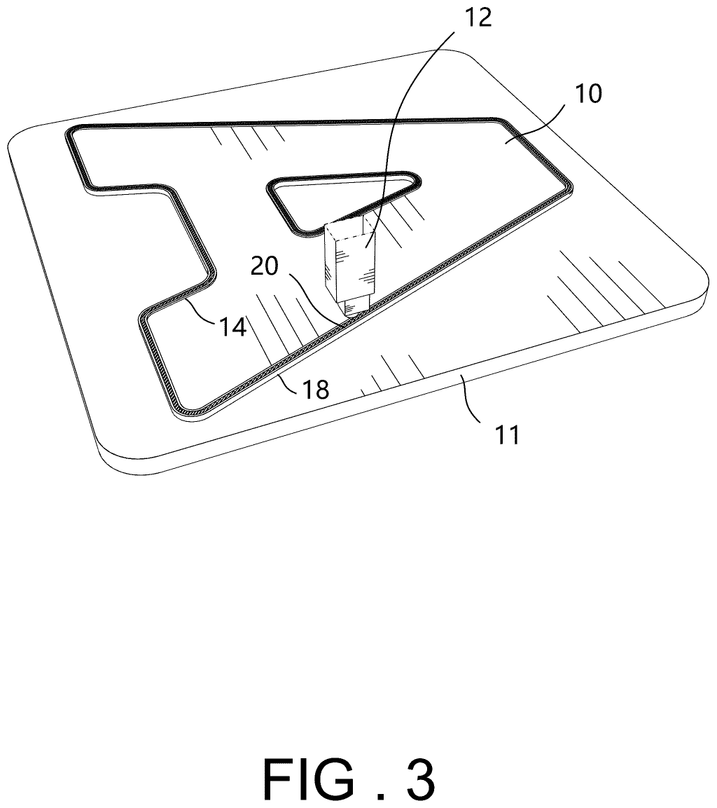

The method of the present invention begins with 3D printing of outer and inner side walls 14 and 18 of channel letter 10 located on 3D printing platform 11. Space 16 is located between side walls 14 and 18. See FIG. 2. 3D printing tool 12 operates to 3D print fortifying layer 20, having a structural pattern within space 14 located between side walls 14 and 18. See FIG. 3. The structural pattern of fortifying layer 20 can take various forms, including, but not limited to X-shaped or S-shaped design structures, depending on desired strength and flexibility characteristics. Fortifying layer 20 serves to provide internal support, security bonding side walls 14 and 18 together, and reinforcement of the structural integrity of channel member 10.

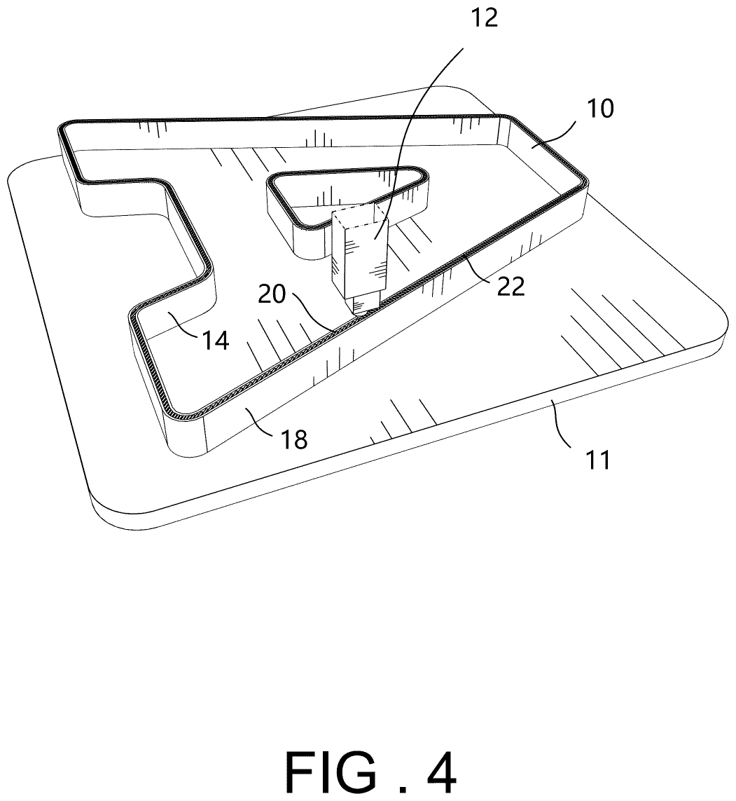

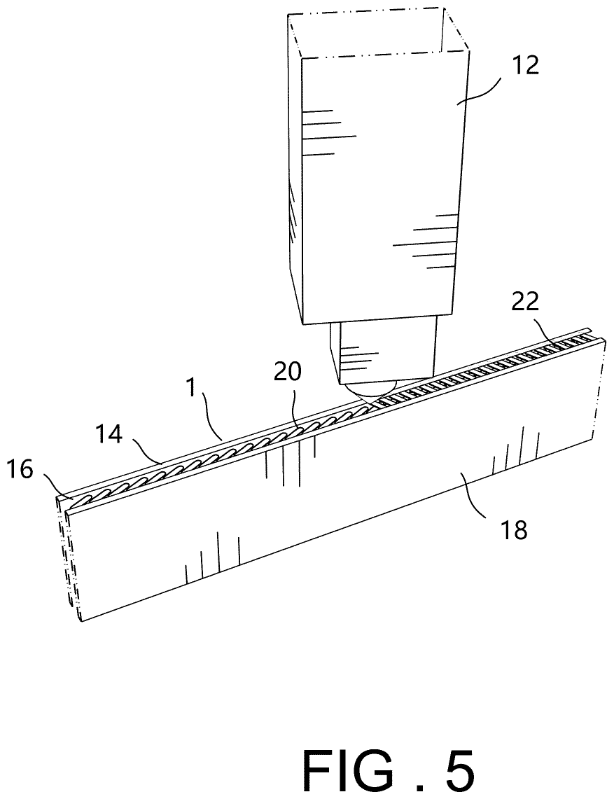

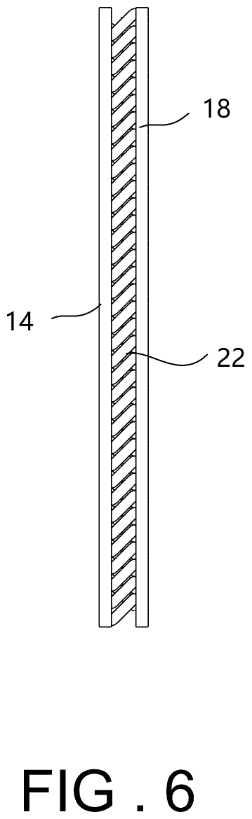

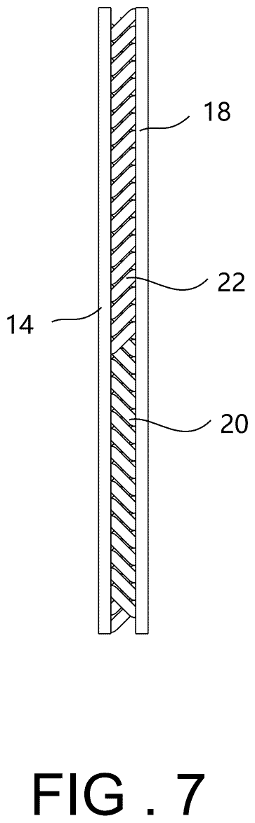

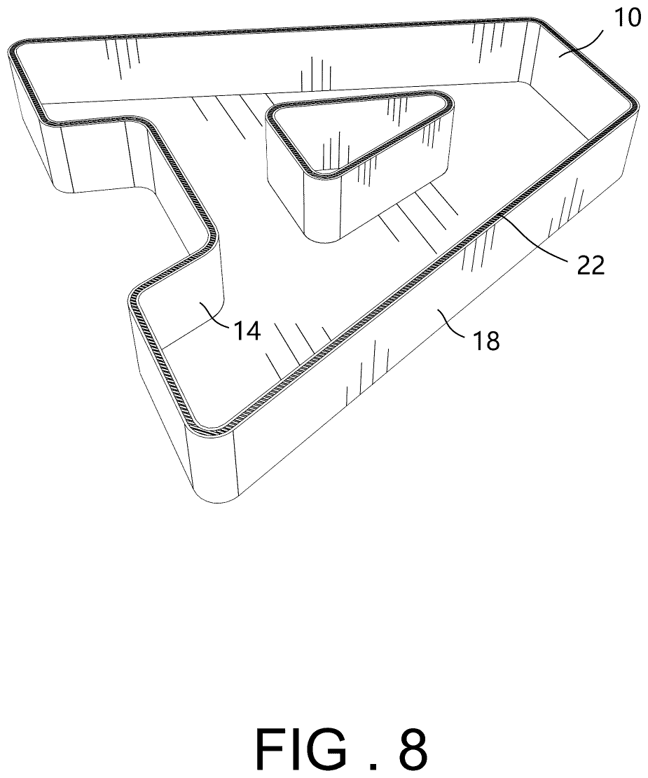

Outer layer 22 is next 3D printed over fortifying layer 20, thereby encapsulating the fortifying layer. See FIGS. 4-7. FIG. 8 shows the fully fabricated channel letter 10.

The incorporation of the fortifying layer creates stronger and more resilient channel members, preventing the delamination or breakage commonly seen in traditional 3D printed letters. This method also significantly increases the lifespan of the printed channel letters, making them more suitable for demanding applications such as outdoor signage.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A method of structurally reinforcing 3D printed channel letters, the method comprising the steps of:
providing a 3D printing tool;
3D printing a channel letter having two side walls with a space therebetween, the side walls forming the basic shape of the channel letter;
3D printing a fortifying layer having a structural pattern within the space between the side walls;
securely bonding the side walls together upon the addition of the 3D printed fortifying layer; and
reinforcing the structural integrity of the channel letter upon the addition of the 3D printed layer.

2. The method as in claim 1 comprising the further step of 3D printing an outer layer over the fortifying layer.

3. The method as in claim 2 comprising the further step of encapsulating the fortifying layer with the outer layer.

4. The method as in claim 1 wherein the structural pattern is S-shaped.

5. The method as in claim 1 wherein the structural pattern is X-shaped.
